(19) United States
(12) Patent Application Publication
(10) Pub. No.: US 2020/0375111 A1
(43) Pub. Date: Dec. 3, 2020

(54) ROBOTIC HARVESTING SYSTEM AND METHOD

(71) Applicant: Gideon Avigad, London (CA)

(72) Inventor: Gideon Avigad, London (CA)

(21) Appl. No.: 16/429,036

(22) Filed: Jun. 2, 2019

(51) Int. Cl. A01D 46/30

(52) U.S. Cl. CPC A01D 46/30

(57) ABSTRACT

A harvesting system having a robotic picking manipulator that is configured to grasp any item of produce of a plurality of items of produce located on a plant. A robotic transport manipulator is configured to receive the grasped item from the robotic picking manipulator at one of at least one hand-over locations and configured to transport the received item to one of at least one drop off locations. A management module is configured to receive information about a particular item of produce of the plurality of items of produce, utilize the information to identify a set of characteristics of the particular item, determine, from the at least one drop off locations, a designated drop off location designated for receiving the particular item, the designated drop off location having a known position relative to the robotic picking manipulator and the robotic transport manipulator and determine, based at least in part on the set of characteristics of the particular item and the known position of the designated drop off location, a harvesting strategy for operating the robotic picking manipulator to move the particular item while grasped by the robotic picking manipulator to the one of the at least one hand-over locations and for operating the robotic transport manipulator to move the received item from the hand-over location to the designated drop off location.

### REFERENCE TO PENDING APPLICATIONS

This application does not claim the benefit of pending application.

### BACKGROUND OF THE INVENTION

### 1. Field of the Invention

The present invention is generally directed toward the harvesting of fruit and vegetables, more specifically toward a system and method to robotically harvest fruit and vegetables.

### 2. Description of the Related Art

Each year, millions of tons of fruit and vegetables are harvested. Most of these crops are picked manually by seasonal workers. With an increase of wages, lodging, transportation and other costs, the profitability for these ventures is decreasing.

Prior art efforts to increase efficiency and profitability relating to crop harvesting has included the use of robotic harvesting systems that pick the crops. These prior art systems typically utilize a robotic arm having a gripping end that designed to secure and remove the fruit or vegetable from its tree, vine, plant or other growing media. The robotic arm then moves a distance away to a conveyor or basket in order to deposit, or drop-off, the fruit or vegetable thereon. This action has disadvantages.

One disadvantage is that the robotic arm needs to move at a relatively slow speed while transporting the fruit or vegetable to the conveyor or basket. This is caused by the manner in which the robotic arm's gripping end holds the fruit or vegetable. To move too fast, the fruit or vegetable may become dislodged from the robotic arm and fall to the ground before reaching the conveyor or basket resulting in a loss of produce. Further, due to this slow cycle time from picking to drop-off back to picking a second fruit or vegetable, the prior art robotic systems are inefficient which results in an increase in costs.

Accordingly, there is a need for an apparatus that can harvest, i.e. pick and transport, fruits and vegetables in a more efficient and secure manner.

### SUMMARY OF THE INVENTION

In one aspect of the present invention, a harvesting system is disclosed. The harvesting system includes a robotic picking manipulator that is configured to grasp any item of produce of a plurality of items of produce located on a plant. The term plant as used herein refers to tree, vine, fungus, plant or other growing media that is capable of growing fruit or vegetables. The term grasp as used herein refers to secure an item of produce while the item is connected to a plant and removing the item from plant.

A robotic transport manipulator is configured to receive the grasped item from the robotic picking manipulator at one of at least one hand-over locations and configured to transport the received item to one of at least one drop off locations. A management module is configured to receive information about a particular item of produce of the plurality of items of produce, utilize the information to identify a set of characteristics of the particular item, determine, from the at least one drop off locations, a designated drop off location designated for receiving the particular item, the designated drop off location having a known position relative to the robotic picking manipulator and the robotic transport manipulator and determine, based at least in part on the set of characteristics of the particular item and the known position of the designated drop off location, a harvesting strategy for operating the robotic picking manipulator to move the particular item while grasped by the robotic picking manipulator to the one of the at least one hand-over locations and for operating the robotic transport manipulator to move the received item to the designated drop off location. The harvesting strategy allows for coordinated movement between the robotic picking manipulator and the robotic transport manipulator. This coordinated movement allows for a shorter cycle time between the picking of multiple pieces of fruit or vegetables. This shorter cycle time results in a more efficient harvesting of a crop.

In some aspects, the management module may further be configured to generate instructions to cause the robotic picking manipulator to grasp the particular item so that the particular item becomes a grasped particular item, generate instructions to cause the robotic picking manipulator to move the grasped particular item to the one of the at least one hand-over locations based on the harvesting strategy and generate instructions to cause the robotic picking manipulator to release the grasped particular item at the one of the at least one hand-over locations based on the harvesting strategy.

In some aspects the management module may be further configured to generate instructions to cause the robotic transport manipulator to receive the particular item from the robotic picking manipulator at the one of the at least one hand-over locations based on the harvesting strategy so that the particular item becomes a received particular item, generate instructions to cause the robotic transport manipulator to move the received particular item to the designated drop off location based on the harvesting strategy and generate instructions to cause the robotic transport manipulator to release the received particular item at the designated drop off location based on the harvesting strategy.

In some aspects, the management module may be further configured to determine a picking strategy for grasping the particular item with the robotic picking manipulator so as to form a determined grasping strategy and determine the harvesting strategy based at least in part on the determined grasping strategy.

In some aspects, the management module may be further configured to determine a transport strategy for moving the particular item with the robotic transport manipulator so as to form a determined transport strategy and determine the harvesting strategy based at least in part on the determined transport strategy.

In the some aspects, the set of characteristics includes at least one of: a mass of the particular item, a geometric characteristic of the particular item, a surface characteristic of the particular item, a deformability of the particular item, a characteristic determined based on information received about the particular item from one or more sensors, such as the ripeness of the item, or a characteristic determined based on stored information about the particular item.

In some aspects, the management module may be further configured to determine the harvesting strategy based at least in part on one or more characteristics of the robotic picking manipulator that include at least one of: a picking end effector associated with the robotic picking manipulator, degrees of freedom of the robotic picking manipulator, types of motion possible with the robotic picking manipulator, a range of motion of the robotic picking manipulator, velocity attainable by the robotic picking manipulator, or space occupied by the robotic picking manipulator when performing particular movements.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

Various embodiments in accordance with the present disclosure will be described with reference to the drawings, in which:

FIG. 1 illustrates an example of a harvest system having a robotic picking arm configured for grasping an item of produce and a robotic transport arm configured to transport the item of produce according to various embodiments;

FIG. 2 illustrates in greater detail the components of an example management module that may be utilized in particular embodiments of the harvest system shown in FIG. 1;

FIG. 3 illustrates a robotic picking arm capable of picking an item of produce according to various embodiments;

FIG. 4 illustrates a robotic transport arm capable of transporting an item of produce to a drop off location according to various embodiments;

FIG. 5 is a flowchart illustrating an example of a process that may be performed for managing harvested items of produce in a harvest system according to certain embodiments; and

FIG. 6 illustrates an environment in which various features of the harvest system can be implemented, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments herein are directed to an inventory system having multiple inventory holders and drive units for moving the inventory holders. Specifically, features herein are directed to robotic arms or manipulators and associated components that may facilitate the movement of inventory items and other features of the inventory system among and between elements of the inventory system. The robotic arms or manipulators may be controlled so as to grasp, move, and release items in manners particularly suited for causing the released items to travel along suitable trajectories from the robotic arms or manipulators to selected drop off locations. For example, a target item, or characteristics thereof, may be identified, such as by optical or other sensors, in order to determine a tossing strategy for tossing the item using a robotic arm to move the item to a receiving zone or location designated for the item.

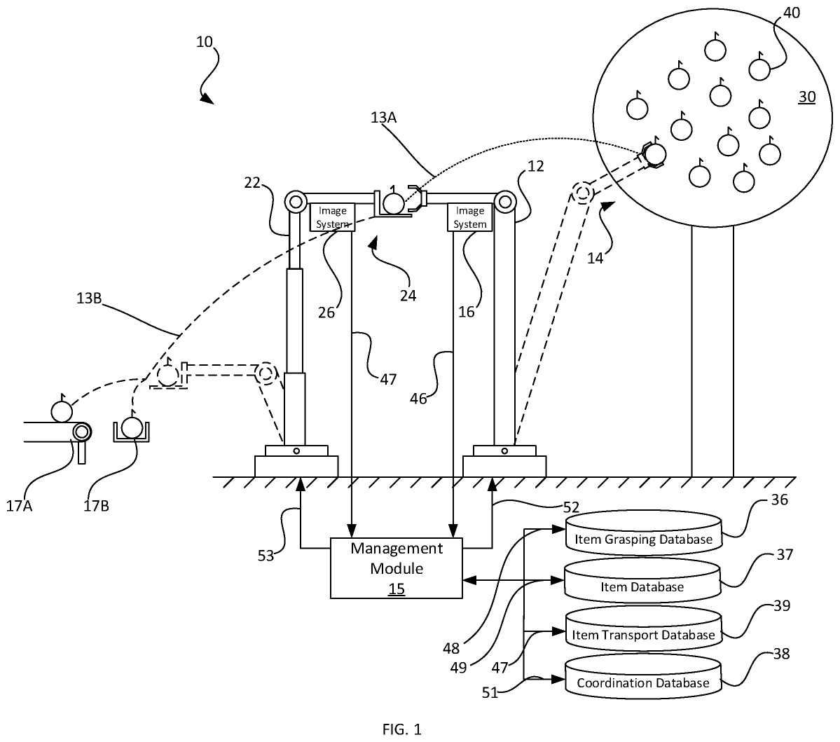

Referring now to the drawings in which like-referenced numerals and/or names may refer to like elements, FIG. 1 illustrates a harvesting system 10 having a robotic picking arm or manipulator 12 configured to pick items of produce 40 and a robotic transport arm or manipulator 22 configured to transport the items of produce 40 to one or more drop off locations 17 (individually identified as 17A and 17B in FIG. 1). Although the description herein primarily refers to a robotic arm, any other mechatronic or robotic device may be used in lieu of or in addition to an arm. The harvesting system 10 may include the robotic picking arm 12, a grasping environment 14, a picking image package 16, robotic transport arm 22, a hand-over environment 24, a transport image package 26, a management module 15, an item grasping database 36, an item database 37, a coordination database 38, item transport database 39, and one or more drop off locations 17 (individually identified as 17A and 17B in FIG. 1).

In operation, the robotic picking arm 12 can pick an item of produce 40, move the item of produce 40 to a hand-over location 24 and releasing the item of produce 40, such as by performing a series of operations that include grasping the item 40, moving the grasped item 40 to a hand-over location 24 and releasing the grasped item 40 at the hand-over location to cause the item of produce 40 to be received by the robotic transport arm 22. The robotic transport arm 22 can receive the item of produce 40 from the robotic picking arm 12, transport the item of produce 40 to a drop off location 17 and release the item of produce 40 at the drop off location 17. In various embodiments, utilizing a robotic picking arm 12 and a robotic transport arm 22 to pick and transport an item of produce 40 to a drop off location 17 can improve throughput through the harvesting system 10, such as by reducing an amount of time that may otherwise be consumed by operations of utilizing a single robotic arm for grasping and transporting an item of produce 40.

The robotic picking arm 12 may grasp the item of produce 40 from the grasping environment 14. The grasping environment 14, which is depicted in FIG. 1 as a portion of a tree 30, may correspond to any plant, tree, vine, bush or other fruit or vegetable producing plant or growing media (such as the depicted item of produce 40) maintaining an item of produce 40 that is to be grasped by the robotic picking arm 12.

The picking image package 16 and the transport image package 26 may include one or more sensors (of like or varying type) and/or cameras arranged to detect the item of produce 40 while the item 40 is being maintained by the grasping environment 14 of in the hand-over location 24. The image packages 16, 26 communicates detected attributes (as at 46, 47), such as a weight, geometric characteristics (e.g., size, position or orientation), surface characteristics (e.g., how slippery or porous the item is), deformability, ripeness and/or damage of the item of produce 40, to the management module 15. Based on the detected attributes, the management module 15 may access (as at 49), the item database 37, such as to access a record for the item of produce 40. The record can include information about attributes of the item, such as weight, shape, size, or other physical characteristics of the item. Based on the record from the item database 37 and/or the detected attributes from one or both image packages 16, 26 the management module 15 may access (as at 51) the coordination database 38 to access a coordinated transport strategy stored for the item of produce 40 or items with similar characteristics.

The management module 15 can provide instructions to the robotic picking arm 12 for picking the item of produce 40 and the robotic transport arm 24 based on the coordinated transport strategy accessed from the coordination database at 39 (e.g., at 51). The coordinated transport strategy can include information about operating the robotic picking arm 12 and robotic transport arm 22 in a manner that will cause the item of produce 40 to travel along a suitable path 13 (individually identified as 13A and 13B respectively in FIG. 1) to a drop off location 17. For example, the coordinated transport strategy may include any combination of information about how the item of produce 40 is to be grasped by the robotic picking arm 12, how the robotic picking arm 12 is to move to the hand-over location 24 while grasping the item 40, how the robotic picking arm 12 is to release the item of produce at the hand-over location 24, how to move the robotic transport arm 22 is to the hand-over location 24, how the robotic transport arm 22 is to receive the item of produce 40 from the robotic picking arm 12 at the hand-over location, how to move the robotic transport arm 22 to the drop off location 17 at which the robotic transport arm 22 is to release the item of produce 40. The path 13 can represent a path of travel over a known distance from the robotic picking arm 12 and robotic transport arm 22 to the designated drop off location 17. The path 13 can include a horizontal and a vertical component of the path of travel of the item of produce 40.

In some aspects, the management module 15 can provide instructions to the robotic picking arm 12 for gripping the item of produce 40 based on a grasping strategy accessed from the item grasping database 36 (e.g., at 48) and, can provide instructions to the robotic transport arm 22 for transporting the item of produce 40 based on a transport strategy accessed from the item transport database 39 (e.g., at 47).

In other aspects, the management module 15 may access a particular grasping strategy from the item grasping database 36 (e.g., at 48) and/or a particular transport strategy from the item transport database 39 (e.g. at 47) based on the coordination transport strategy accessed from the coordination database 38 at 51. The item database 37, the item grasping database 36, the item transport database 39 and the coordination database 38 (or any combination thereof), although depicted as separate in FIG. 1, may share structure and/or content.

Any suitable drop off location 17 can be provided. In the embodiment illustrated in FIG. 1, the drop off locations 17A-17B include a first drop off location 17A provides a conveyor belt while a second drop off location 17B provides a produce container. However, any other suitable arrangement of drop off locations 17 can be utilized, including a set of produce containers.

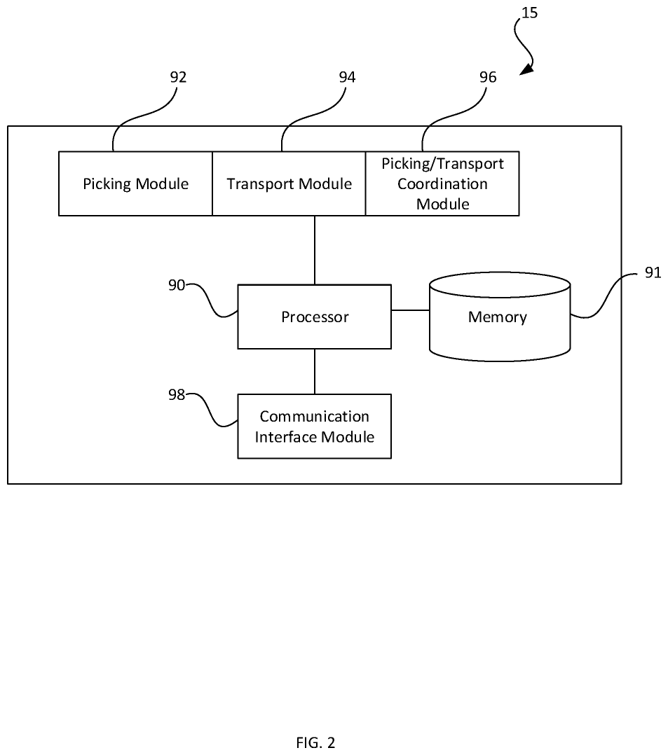

Management module 15 assigns tasks to appropriate components of harvest system 10 and coordinates operation of the various components in completing the tasks. These tasks may relate to the movement and processing of items of produce. Although shown in FIG. 2 as a single, discrete component, management module 15 may represent multiple components and may represent or include portions of other elements of harvest system 10. As a result, any or all of the interaction between a particular robotic arm 12, 22 and management module 15 that is described below may, in particular embodiments, represent peer-to-peer communication between that robotic arm 12, 22 and one or more other robotic arms 12, 22.

FIG. 2 illustrates in greater detail the components of a particular embodiment of management module 15. As shown, the example embodiment includes a picking module 92, a transport module 94, a picking/transport coordination module 96 a communication interface module 98, a processor 90, and a memory 91. Management module 15 may represent a single component, multiple components located at a central location within harvest system 10, or multiple components distributed throughout inventory system 10. In general, management module 15 may include any appropriate combination of hardware and/or software suitable to provide the described functionality.

Processor 90 is operable to execute instructions associated with the functionality provided by management module 15. Processor 90 may comprise one or more general purpose computers, dedicated microprocessors, or other processing devices capable of communicating electronic information. Examples of processor 90 include one or more application-specific integrated circuits (ASICs), field programmable gate arrays (FPGAs), digital signal processors (DSPs) and any other suitable specific or general purpose processors.

Memory 91 stores processor instructions, inventory requests, reservation information, state information for the various components of inventory system 10 and/or any other appropriate values, parameters, or information utilized by management module 15 during operation. Memory 91 may represent any collection and arrangement of volatile or nonvolatile, local or remote devices suitable for storing data. Examples of memory 91 include, but are not limited to, random access memory (RAM) devices, read only memory (ROM) devices, magnetic storage devices, optical storage devices or any other suitable data storage devices.

Picking module 92 processes received picking requests and generates one or more assigned tasks to be completed by the components of harvest system 10. Picking module 92 may also select one or more appropriate components for completing the assigned tasks and, using communication interface module 98, communicate the assigned tasks to the relevant components.

Transport module 94 processes received transport requests and generates one or more assigned tasks to be completed by the components of harvest system 10. Transport module 94 may also select one or more appropriate components for completing the assigned tasks and, using communication interface module 98, communicate the assigned tasks to the relevant components.

Picking/transport coordination module 96 processes received transport path requests and generates one or more routes for moving an item of produce 40 from being grasped by the robotic picking arm 12 to the transport of that item of produce 40 by the robotic transport arm 24 to the drop off location 17. Picking/transport coordination module 96 generates a path to one or more destinations identified in the route request. Picking/transport coordination module 96 may implement any appropriate algorithms utilizing any appropriate parameters, factors, and/or considerations to determine the appropriate path. After generating an appropriate path, Picking/transport coordination module 96 transmits a route response identifying the generated path to robotic picking arm 12 and the robotic transport arm 22 using communication interface module 98.

Communication interface module 98 facilitates communication between management module 15 and other components of harvesting system 10, including route requests, route responses, and task assignments. These route requests, route responses, and task assignments may represent communication of any form appropriate based on the capabilities of management module 15 and may include any suitable information. Depending on the configuration of management module 15, communication interface module 98 may be responsible for facilitating either or both of wired and wireless communication between management module 15 and the various components of harvest system 10. In particular embodiments, management module 15 may communicate using communication protocols such as 802.11 Bluetooth, or Infrared Data Association (IrDA) standards. Furthermore, management module 15 may, in particular embodiments, represent a portion of mobile drive unit 20 or other components of inventory system 10. In such embodiments, communication interface module 98 may facilitate communication between management module 15 and other parts of the same system component.

In general, picking module 92, transport module 94, picking/transport coordination module 96, and communication interface module 98 may each represent any appropriate hardware and/or software suitable to provide the described functionality. In addition, as noted above, management module 15 may, in particular embodiments, represent multiple different discrete components and any or all of picking module 92, transport module 94, picking/transport coordination module 96, and communication interface module 98 may represent components physically separate from the remaining elements of management module 15. Moreover, any two or more of picking module 92, transport module 94, picking/transport coordination module 96, and communication interface module 98 may share common components. For example, in particular embodiments, picking module 92, transport module 94, and picking/transport coordination module 96 represent computer processes executing on processor 90 and communication interface module 98 comprises a wireless transmitter, a wireless receiver, and a related computer process executing on processor 90.

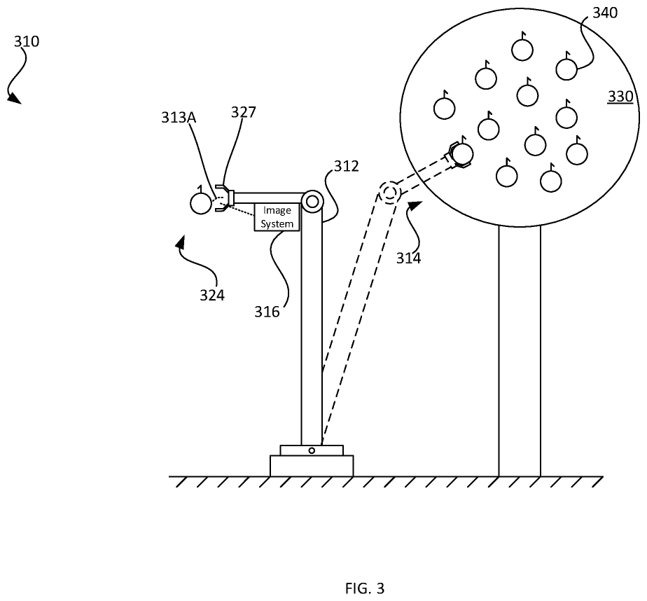

As described above, embodiments herein are directed to picking items of produce using robotic picking arms or manipulators 312 within a harvest system. FIG. 3 illustrates an example harvest system 310 having a robotic picking arm 312 capable of picking an item of produce 340 and to move the item of produce 340 to a hand-over location 324 resulting in the release of the item of produce 340 along a path 313A.

The robotic picking arm 312 can utilize any suitable end effector 327 (or combination of end effectors 327) to engage the item of produce 340 to facilitate grasping the item of produce 340. Examples of suitable end effectors 327 include, but are not limited to, soft robotic effectors, vacuum effectors, electro-adhesion effectors, and mechanical or electromechanical effectors. Soft robotic end effectors may generally include flexible structures that may be manipulated between various orientations. The structures may include silicon bodies or other flexible material. Manipulation of the flexible material may be achieved through use of flexible actuators such as air muscles (e.g., contractile or extensional devices operated by pressurized air movement relative to filling or emptying a pneumatic bladder), electro-active polymers e.g., polymers which change size or shape when stimulated by an electric field), or ferrofluids (e.g., fluids having suspended ferro-magnetic particles capable of altering a size or shape of the fluid volume when subjected to a magnetic field). Vacuum end effectors may grasp items using suction. Electro-adhesion end effectors can include an array of electrodes arranged along a flexible or rigid substrate capable of applying a charge (akin to static electricity) that can adhere an item to the substrate portions that are in contact with the item. Mechanical or electromechanical end effectors may include pinchers, claws, grippers, or other rigid components that may be actuated relative to one another for grasping an item. Other end effectors may also be utilized to facilitate additional grasping and/or tossing techniques. As an example, an end effector may include a platform or other structure that can be placed underneath an item (e.g., by scooping the item or as a result of the item dropping onto the platform) so as to grasp the item by supporting the item from underneath.

In some aspects, the robotic picking arm 312 may alter the desired path 313A or provide a different path 313A based on an end effector 327 utilized by the robotic picking arm 312. The end effector 327 used by the robotic picking arm 312 may have an effect on different operations associated with the grasping and moving. For example, the end effector 327 may affect how the item of produce 340 is grasped for the movement to the hand-over location 324. Grasping may include any physical manipulation of objects, including, but not limited to, picking up, pushing, pulling, compressing, stretching, supporting, and moving.

The end effector 327 may also affect how the item of produce 340 is ultimately released or separates from the robotic picking arm 312. For example, an end effector 327 with a mechanical pincher may open the pincher to release the item of produce 340 at a particular release point during movement of the robotic picking arm 312 to provide the item of produce 340 with a particular initial position and initial velocity for achieving the intended path 313. In some aspects, the end effector 327 may provide additional forces or effects for changing or affecting a starting state of the item of produce 340 being released. For example, a vacuum end effector may reverse suction so as to provide a propelling effect to the tossed item produce 340 at the start of the path 313A.

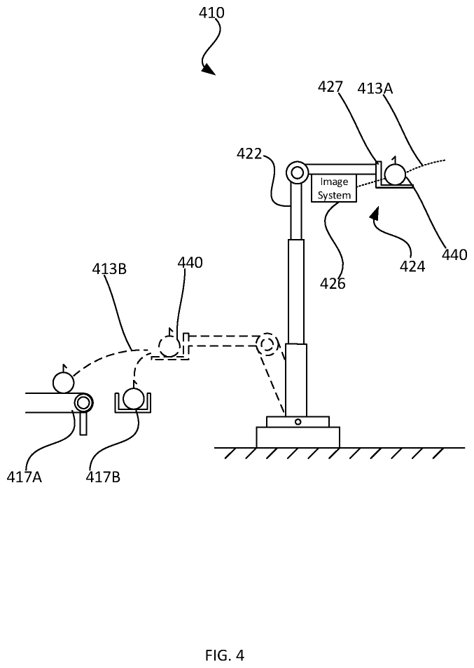

As described above, embodiments herein are directed to transporting items of produce using robotic transport arms or manipulators 422 within a harvest system. FIG. 4 illustrates an example harvest system 410 having a robotic transport arm 422 capable of receiving an item of produce 440 at a hand-over location 424 along a path 413A and to move the item of produce 440 to a release location 417 resulting in the release of the item of produce 440 along a path 413B.

The robotic transport arm 422 can utilize any suitable end effector 427 (or combination of end effectors 427) to engage the item of produce 440 to facilitate the transporting of the item of produce 440. Examples of suitable end effectors 427 include, but are not limited to, soft robotic effectors, vacuum effectors, electro-adhesion effectors, and mechanical or electromechanical effectors. Soft robotic end effectors may generally include flexible structures that may be manipulated between various orientations. The structures may include silicon bodies or other flexible material. Manipulation of the flexible material may be achieved through use of flexible actuators such as air muscles (e.g., contractile or extensional devices operated by pressurized air movement relative to filling or emptying a pneumatic bladder), electro-active polymers e.g., polymers which change size or shape when stimulated by an electric field), or ferrofluids (e.g., fluids having suspended ferro-magnetic particles capable of altering a size or shape of the fluid volume when subjected to a magnetic field). Vacuum end effectors may grasp items using suction. Electro-adhesion end effectors can include an array of electrodes arranged along a flexible or rigid substrate capable of applying a charge (akin to static electricity) that can adhere an item to the substrate portions that are in contact with the item. Mechanical or electromechanical end effectors may include pinchers, claws, grippers, or other rigid components that may be actuated relative to one another for grasping an item. Other end effectors may also be utilized to facilitate additional grasping and/or tossing techniques. As an example, an end effector may include a platform or other structure that can be placed underneath an item (e.g., by scooping the item or as a result of the item dropping onto the platform) so as to grasp the item by supporting the item from underneath.

In some aspects, the robotic transport arm 422 may alter the desired path 413, or provide a different path 413 based on an end effector 427 utilized by the robotic transport arm 422. The end effector 427 used by the robotic transport arm 422 may have an effect on different operations associated with the grasping and moving. For example, the end effector 427 may affect how the item of produce 440 is received at the hand-over location 424.

The end effector 427 may also affect how the item of produce 440 is ultimately released or separates from the robotic transport arm 412. For example, an item 440 moved by an end effector 427 with a platform that supports the item of produce 440 from beneath may separate from the end effector 427 and start a trajectory as a result of motion of the robotic transport arm 422, such as a sudden stop of the robotic transport arm 422, rather than an active releasing operation of the end effector 427.

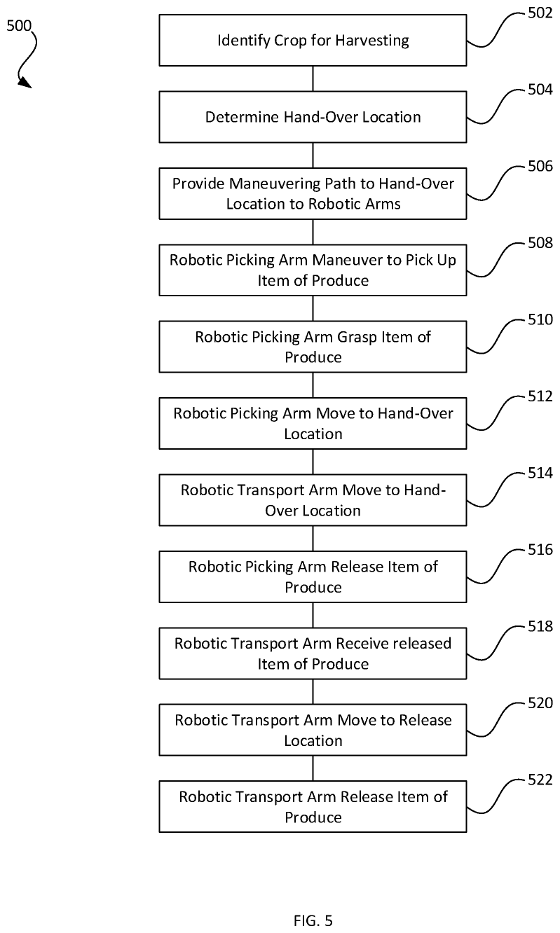

FIG. 5 illustrates an example of a process 500 that can be performed to coordinate harvesting of items of produce. Some or all of the process 500 (or any other processes described herein, or variations and/or combinations thereof) may be performed under the control of one or more computer systems configured with executable instructions, such as the modules described herein (e.g., those discussed with respect to the management module 15 of FIG. 1), and may be implemented as code (e.g., executable instructions, one or more computer programs or one or more applications) executing collectively on one or more processors, by hardware or combinations thereof. The code may be stored on a computer-readable storage medium, for example, in the form of a computer program including a plurality of instructions executable by one or more processors. The computer-readable storage medium may be non-transitory. Moreover, unless indicated otherwise, acts shown in the processes are not necessary performed in the order shown, and/or some acts can be omitted in embodiments.

The process 500 at 502 can include identifying the crop for harvesting, including the locations of the individual items of produce to be harvested. For example, the item of produce may be identified based on sensor information (e.g., from the picking image package 16 described in FIG. 1) and/or based on information stored about the item of produce (e.g., in the item database 37 in FIG. 1). This may include identifying a set of characteristics (which may include one or more characteristics) of the item.

In some aspects, identifying the item of produce at 502 may include identifying whether the item of produce is deemed harvestable. For example, if an item of produce is determined to be too fragile, too small, unripe or damaged, the item of produce may be ignored.

The process 500 at 504 can include determining, by the management module 15, the most efficient hand-over location between the robotic picking arm 12 and robotic transport arm 22.

The process 500 at 506 can include providing the most efficient maneuvering path for the robotic picking arm 12 and robotic transport arm 22 to follow in order to efficiently arrive at the determined hand-over location, and for the robotic transport arm to follow in order to efficiently arrive at the determined release location.

The process 500 at 508 can include maneuvering the robotic picking arm 12 to the item of produce 40. For example, the robotic picking arm may be instructed to maneuver to the grasping environment 14 using a particular path.

The process 500 at 510 can include grasping the item of produce. For example, the robotic picking arm may be instructed to grasp the item using any appropriate end effector from any appropriate orientation, or combination of end effectors and/or robotic arms. For example, the robotic picking arm may use information identified at 502 about an orientation of the item to facilitate grasping the item.

The process 500 at 512, 514 can include moving the robotic picking arm 12 and robotic transport arm 22 to the hand-over location 24 by the determined efficient path.

The process 500 at 516, 518 can include the robotic picking arm 12 releasing the item of produce 40 and the robotic transport arm 22 receiving the released item of produce 40. For example, the robotic picking arm 12 may be instructed to release the item of produce 40 at a particular orientation, while the robotic transport arm 22 may be instructed to receive the item of produce using any appropriate end effector from any appropriate orientation, or combination of end effectors and/or robotic arms.

The process 500 at 520 can include moving the robotic transport arm 22 along the determined efficient path, and at 522, can include the robotic transport arm 22 releasing the item of produce 40 at the release location. For example, the robotic transport arm 22 may be instructed to release the item of produce 40 at a particular orientation using any appropriate end effector from any appropriate orientation, or combination of end effectors and/or robotic arms.

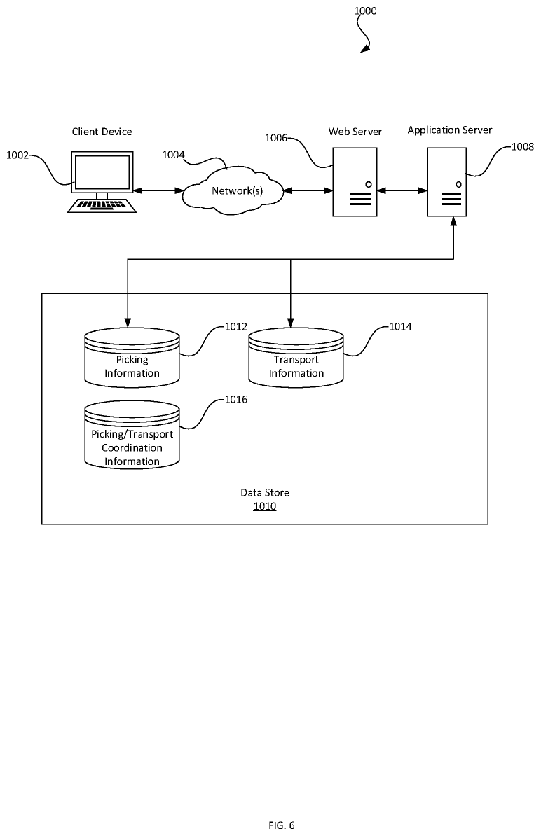

FIG. 6 illustrates aspects of an example environment 1000 for implementing aspects in accordance with various embodiments. As will be appreciated, although a Web-based environment is used for purposes of explanation, different environments may be used, as appropriate, to implement various embodiments. The environment includes an electronic client device 1002, which can include any appropriate device operable to send and receive requests, messages, or information over an appropriate network 1004 and convey information back to a user of the device. Examples of such client devices include personal computers, cell phones, handheld messaging devices, laptop computers, set-top boxes, personal data assistants, electronic book readers, and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 1006 for receiving requests and serving content in response thereto, although for other networks an alternative device serving a similar purpose could be used as would be apparent to one of ordinary skill in the art.

The illustrative environment includes a least one application server 1008 and a data store 1010. It should be understood that there can be several application servers, layers, or other elements, processes or components, which may be chained or otherwise configured, which can interact to perform tasks such as obtaining data from an appropriate data store. As used herein the term “data store” refers to any device or combination of devices capable of storing, accessing, and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device, handling a majority of the data access and business logic for an application. The application server provides access control services in cooperation with the data store and is able to generate content such as text, graphics, audio and/or video to be transferred to the user, which may be served to the user by the Web server in the form of HyperText Markup Language (“HTML”), Extensible Markup Language (“XML”) or another appropriate structured language in this example. The handling of all requests and responses, as well as the delivery of content between the client device 1002 and the application server 1008, can be handled by the Web server. It should be understood that the Web and application servers are not required and are merely example components, as structured code discussed herein can be executed on any appropriate device or host machine as discussed elsewhere herein.

The data store 1010 can include several separate data tables, databases or other data storage mechanisms and media for storing data relating to a particular aspect. For example, the data store illustrated includes mechanisms for storing information which can be used by modules described herein, such as picking information 1012, transport information 1014, and/or picking/transport coordination information 1016. It should be understood that there can be many other aspects that may need to be stored in the data store, such as for page image information and to access right information, which can be stored in any of the above listed mechanisms as appropriate or in additional mechanisms in the data store 1010. The data store 1010 is operable, through logic associated therewith, to receive instructions from the application server 1008 and obtain, update or otherwise process data in response thereto.

Each server typically will include an operating system that provides executable program instructions for the general administration and operation of that server and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 6. Thus, the depiction of the system 1000 in FIG. 6 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network, and/or any combination thereof.

In embodiments utilizing a Web server, the Web seer can run any of a variety of server or mid-tier applications, including Hypertext Transfer Protocol (“HTTP”) servers, FTP servers, Common Gateway Interface (“CGP”) servers, data servers, Java servers and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Pert, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen or keypad) and at least one output device (e.g., a display device, printer or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.) and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the a system device. Based at least in part on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this disclosure are described herein, including the best mode known to the inventors for carrying out the invention. Variations of those preferred embodiments may become apparent to those of ordinary skill in the art upon reading the foregoing description. The inventors expect skilled artisans to employ such variations as appropriate and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

I claim:

1. A harvesting system, comprising:
a robotic picking manipulator configured to grasp any item of produce of a plurality of items of produce located on a plant;
a robotic transport manipulator configured to receive the grasped item of produce of a plurality of items of produce from the robotic picking manipulator at one of at least one hand-over locations and configured to transport the received item to one of at least one drop off locations; and
a management module configured to:
receive information about at least one particular item of produce of the plurality of items of produce;
utilize the information to identify a set of characteristics of the at least one particular item;
determine, from the at least one drop off locations, a designated drop off location designated for receiving the at least one particular item, the designated drop off location having a known position relative to the robotic picking manipulator and the robotic transport manipulator; and
determine, based at least in part on the set of characteristics of the at least one particular item and the known position of the designated drop off location, a harvesting strategy for operating the robotic picking manipulator to grasp one of the at least one particular item located on the plant, move the grasped one particular item while grasped by the robotic picking manipulator to the one of the at least one hand-over locations, to move the robotic transport manipulator to the one of the at least one hand-over locations and for operating the robotic transport manipulator to receive the grasped one particular item from the robotic picking manipulator and move the received item to the designated drop off location.

2. The harvesting system of claim 1, wherein the management module is further configured to:
generate instructions to cause the robotic picking manipulator to grasp the particular item so that the particular item becomes a grasped particular item;
generate instructions to cause the robotic picking manipulator to move the grasped particular item to the one of the at least one hand-over locations based on the harvesting strategy; and
generate instructions to cause the robotic picking manipulator to release the grasped particular item at the one of the at least one hand-over locations based on the harvesting strategy.

3. The harvesting system of claim 1, wherein the management module is further configured to:
generate instructions to cause the robotic transport manipulator to move to the one of the at least one hand-over locations and receive the particular item from the robotic picking manipulator at the one of the at least one hand-over locations based on the harvesting strategy so that the particular item becomes a received particular item;
generate instructions to cause the robotic transport manipulator to move the received particular item to the designated drop off location based on the harvesting strategy; and
generate instructions to cause the robotic transport manipulator to release the received particular item at the designated drop off location based on the harvesting strategy.

4. The harvesting system of claim 3, wherein the management module is further configured to:
generate instructions to cause the robotic picking manipulator to grasp the particular item so that the particular item becomes a grasped particular item;
generate instructions to cause the robotic picking manipulator to move the grasped particular item to the one of the at least one hand-over locations based on the harvesting strategy; and
generate instructions to cause the robotic picking manipulator to release the grasped particular item at the one of the at least one hand-over locations based on the harvesting strategy.

5. The harvesting system of claim 1, wherein the management module is further configured to:
determine a picking strategy for grasping the particular item with the robotic picking manipulator so as to form a determined grasping strategy; and
determine the harvesting strategy based at least in part on the determined grasping strategy.

6. The harvesting system of claim 1, wherein the management module is further configured to:
determine a transport strategy for moving the particular item with the robotic transport manipulator so as to form a determined transport strategy; and
determine the harvesting strategy based at least in part on the determined transport strategy.

7. The harvesting system of claim 6, wherein the management module is further configured to:
determine a picking strategy for grasping the particular item with the robotic picking manipulator so as to form a determined grasping strategy; and
determine the harvesting strategy based at least in part on the determined grasping strategy and at least in part on the determined transport strategy.

8. The harvesting system of claim 1, wherein the management module is further configured to:
determine a picking strategy for grasping the particular item with the robotic picking manipulator based at least in part on the harvesting strategy.

9. The harvesting system of claim 1, wherein the management module is further configured to:
determine a transport strategy for moving the particular item with the robotic transport manipulator based at least in part on the harvesting strategy.

10. The harvesting system of claim 1, wherein the set of characteristics includes at least one of:
a mass of the particular item;
a geometric characteristic of the particular item;
a surface characteristic of the particular item;
a deformability of the particular item;
a characteristic determined based on information received about the particular item from one or more sensors; or
a characteristic determined based on stored information about the particular item.

11. The harvesting system of claim 1, wherein the management module is further configured to determine the harvesting strategy based at least in part on one or more characteristics of the robotic picking manipulator that include at least one of:
a picking end effector associated with the robotic picking manipulator;
degrees of freedom of the robotic picking manipulator;
types of motion possible with the robotic picking manipulator;
a range of motion of the robotic picking manipulator;
velocity attainable by the robotic picking manipulator; or
space occupied by the robotic picking manipulator when performing particular movements.

12. The harvesting system of claim 1, wherein the management module is further configured to determine the harvesting strategy based at least in part on one or more characteristics of the robotic transport manipulator that include at least one of:
a transport end effector associated with the robotic transport manipulator;
degrees of freedom of the robotic transport manipulator;
types of motion possible with the robotic transport manipulator;
a range of motion of the robotic transport manipulator;
velocity attainable by the robotic transport manipulator; or
space occupied by the robotic transport manipulator when performing particular movements.
